(19) United States
(12) Patent Application Publication
(10) Pub. No.: US 2026/0104736 A1
(43) Pub. Date: Apr. 16, 2026

(54) WEARABLE ELECTRONIC DEVICE

(71) Applicant: Samsung Display Co., Ltd., Yongin-Si (KR)

(72) Inventors: Gyeong Sang PARK, Yongin-si (KR); KYOUNGIN LEE, Yongin-si (KR); SEOYOUNG CHOI, Yongin-si (KR)

(21) Appl. No.: 19/273,134

(22) Filed: Jul. 18, 2025

(30) Foreign Application Priority Data
Oct. 14, 2024 (KR) 10-2024-0139468

(51) Int. Cl. G06F 1/16

(52) U.S. Cl. CPC G06F 1/1637; G06F 1/163; G06F 1/1656

(57) ABSTRACT

A wearable electronic device according to an embodiment includes a display, a first plate positioned on the display, a protective ink layer covering a portion of the first plate, and a housing positioned on the first plate, wherein the first plate includes a first surface, a first side surface connected to the first surface, and a second surface connected to the first side surface and overlapping the first surface, the first side surface has a stepped shape, and the protective ink layer covers a portion of the first side surface.

### CROSS-REFERENCE TO RELATED APPLICATION

This application claims priority to and the benefit of Korean Patent Application No. 10-2024-0139468 filed at the Korean Intellectual Property Office on Oct. 14, 2024, the entire contents of which are incorporated herein by reference.

### BACKGROUND

### (a) Field

The present disclosure relates to a wearable electronic device.

### (b) Description of the Related Art

With the development of electronic, information, and communication technologies, a single electronic device now includes a variety of functions. As electronic devices have improved in performance and become smaller, carrying and using electronic devices has become more common and various types of portable electronic devices is available. For example, a user may carry and use multiple portable electronic devices such as a smartphone, a tablet PC, a smartwatch, wireless earphones, and/or smartglasses.

### SUMMARY

The embodiments attempt to provide a wearable electronic device with improved reliability of a first plate.

A wearable electronic device according to an embodiment includes a display, a first plate positioned on the display, a protective ink layer covering a portion of the first plate, and a housing positioned on the first plate, wherein the first plate includes a first surface, a first side surface connected to the first surface, and a second surface connected to the first side surface and overlapping the first surface, and wherein the first side surface has a stepped shape, and the protective ink layer covers a portion of the first side surface.

The protective ink layer may not overlap the first surface or the second surface.

The protective ink layer may expose a remaining portion of the first side surface.

The first side surface may include a first sub-side surface connected to the first surface, a second sub-side surface connected to the first sub-side surface, and a third sub-side surface connected to the second surface and a second sub-side surface.

The second sub-side surface may be parallel to the first surface and the second surface.

The protective ink layer may cover at least a portion of the second sub-side surface.

The protective ink layer may cover at least a portion of the third sub-side surface.

The wearable electronic device may further include a light shielding adhesive layer positioned on the second sub-side surface.

The light shielding adhesive layer may be in contact with the protective ink layer.

The light shielding adhesive layer may be positioned between the protective ink layer and the housing.

The wearable electronic device may further include a light shielding printed layer positioned on the back surface of the first plate.

A wearable electronic device according to an embodiment includes a display, a first plate positioned on the display, a protective ink layer covering a portion of the first plate, and a housing positioned on the first plate, wherein the first plate includes a first surface, a first side surface connected to the first surface, and a second surface connected to the first side surface and overlapping the first surface, and wherein the protective ink layer covers a portion of the first side surface and exposes the remaining portion of the first side surface, and the housing encloses at least a portion of the first side surface.

The protective ink layer may not overlap the first surface or the second surface.

The first side surface may include a first sub-side surface connected to the first surface, a second sub-side surface connected to the first sub-side surface, and a third sub-side surface connected to the second sub-side surface and the second surface.

The second sub-side surface may be parallel to the first surface and the second surface.

The protective ink layer may cover at least a portion of the second sub-side surface.

The protective ink layer may cover at least a portion of the third sub-side surface.

The wearable electronic device may further include a light shielding adhesive layer positioned on the second sub-side surface.

The light shielding adhesive layer may be positioned between the protective ink layer and the housing.

The wearable electronic device may further include a light shielding printed layer positioned on the back surface of the first plate.

According to embodiments, it may be possible to provide a wearable electronic device with improved reliability of the first plate.

### BRIEF DESCRIPTION OF THE DRAWINGS

FIG. 1 is a front perspective view of a wearable electronic device according to an embodiment.

FIG. 2 is a rear perspective view of a wearable electronic device according to an embodiment.

FIG. 3 is an exploded perspective view of a wearable electronic device according to an embodiment.

FIG. 4 is a top plan view of the front surface of a first plate according to an embodiment.

FIG. 5 is a top plan view of the rear surface of the first plate according to an embodiment.

FIG. 6 is a side view of the first plate according to an embodiment.

FIG. 7 is a cross-sectional view of a pad according to an embodiment.

FIG. 8 is a side view of the embodiment of FIG. 6 with a light shielding adhesive layer added.

### DETAILED DESCRIPTION OF THE EMBODIMENTS

The present disclosure will be described in detail hereinafter with reference to the accompanying drawings, in which embodiments of the present disclosure are shown. As those skilled in the art would realize, the described embodiments may be modified in various different ways, all without departing from the spirit or scope of the present disclosure.

The drawings and description are to be regarded as illustrative in nature and not restrictive, and like reference numerals designate like elements throughout the specification.

Further, since sizes and thicknesses of components shown in the accompanying drawings may be arbitrarily given to facilitate understanding and ease of description, the disclosure is not limited to the illustrated sizes and thicknesses. In the drawings, the thicknesses of layers and regions may be exaggerated for clarity. In the drawings, to facilitate understanding and ease of description, the thicknesses of some layers and regions may be exaggerated.

It should be understood that when an element such as a layer, film, region, or substrate is referred to as being “on” another element, it may be directly on the other element or intervening elements may also be present. In contrast, when an element is referred to as being “directly on” another element, there are no intervening elements present. Further, when an element is referred to as being “on” or “above” a reference element, it may be positioned above or below the reference element, and it may not necessarily be referred to as being positioned “on” or “above” it in a direction opposite to gravity.

In addition, unless explicitly stated to the contrary, the word “comprise” and variations such as “comprises” and “comprising” should be understood to imply the inclusion of stated elements but not the exclusion of any other elements.

In addition, the phrase “in a plan view” means a view from a position above the object (e.g., from the top), and the phrase “in a cross-section” means a view of a cross-section of the object which is vertically cut from the side.

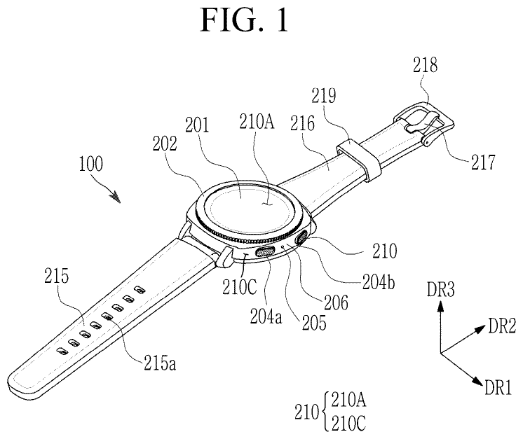

Hereinafter, a wearable electronic device according to an embodiment will be described with reference to FIGS. 1 to 3.

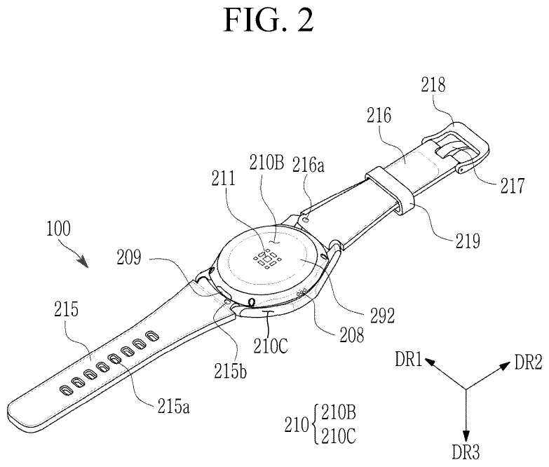

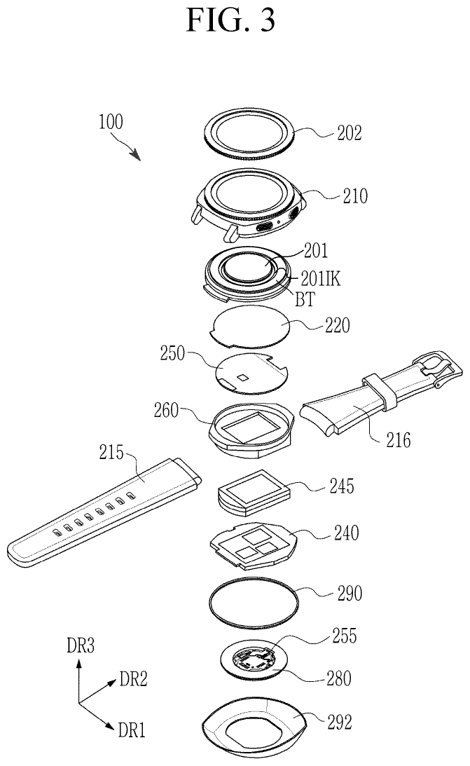

FIG. 1 is a front perspective view of a wearable electronic device according to an embodiment, FIG. 2 is a rear perspective view of a wearable electronic device according to an embodiment, and FIG. 3 is an exploded perspective view showing a wearable electronic device according to an embodiment.

In the detailed description below, in FIGS. 1 to 3, the width direction or the longitudinal direction of a wearable electronic device 100 or a housing 210 (or a side bezel structure) may be any one of the “DR1 axis direction” and the “DR2 axis direction” of the illustrated orthogonal coordinate system.

When a distinction is required between the width direction and the longitudinal direction, the direction of the orthogonal coordinate system depicted in the drawing may be indicated.

In the orthogonal coordinate system of FIGS. 1 to 3, “DR3 axis direction” may refer to the thickness direction of the wearable electronic device 100 or the housing 210.

In an embodiment, the direction in which the front surface (e.g., a first surface 210A of FIG. 1) of the wearable electronic device 100 or the housing 210 faces may be defined as a “first direction” or “+DR3 direction,” and the direction in which the rear surface (e.g., a second surface 210B of FIG. 2) of the wearable electronic device 100 or the housing 210 faces may be defined as a “second direction” or “−DR3 direction.”

Referring to FIGS. 1 and 2, the wearable electronic device 100 according to an embodiment may include the housing 210 including the first surface (or front surface) 210A, the second surface (or rear surface) 210B, and a side surface 210C surrounding a space between the first surface 210A and the second surface 210B, and wearing members 215 and 216 connected to at least a portion of the housing 210 and configured to allow the wearable electronic device 100 or the housing 210 to be worn on a part of the user's body (e.g., a wrist or an ankle).

In another embodiment (not shown), the housing 210 may refer to a structure forming part of the first surface 210A, the second surface 210B, and the side surface 210C of FIG. 1.

According to an embodiment, the first surface 210A may be formed by a first plate 201 (e.g., a glass plate or a polymer plate) that is at least partially substantially transparent.

The second surface 210B may be formed by a second plate 292, at least part of which includes substantially transparent and/or opaque regions.

In an embodiment, when the electronic device includes a first sensor module 211 disposed on the second surface 210B, the second plate 292 may include an at least partially transparent region.

The second plate 292 may be formed of, for example, a coated or colored glass, ceramic, polymer, metal (e.g., aluminum, stainless steel (STS), or magnesium), or a combination of at least two of the above materials.

The side surface 210C is coupled with the first plate 201 and/or the second plate 292, and may be formed by a side bezel structure (or “side member”) 206 including metal and/or polymer.

In an embodiment, the second plate 292 and the side bezel structure 206 may be formed integrally and include the same material (e.g., a metallic material such as aluminum).

The wearing members 215 and 216 may be formed of various materials and shapes.

A woven material, leather, rubber, urethane, metal, ceramic, or a combination of at least two of the above materials may constitute the wearing members 215 and 216.

According to an embodiment, the wearable electronic device 100 may include at least one of a display 220 (see FIG. 3), the first sensor module 211, audio holes 205 and 208, key input devices 202, 204a, and 204b, and a connector hole 209.

In an embodiment, the wearable electronic device 100 may not include at least one of the components (e.g., the key input devices 202, 204a, and 204b, the connector hole 209, or the first sensor module 211) or may additionally include other components.

The display (the display 220 of FIG. 3) may be exposed, for example, through a significant portion of the first plate 201.

The shape of the display (the display 220 of FIG. 3) may correspond to the shape of the first plate 201 and may have various shapes such as a circle, an oval, or a polygon.

The display (the display 220 of FIG. 3) may be coupled with or disposed adjacent to a touch detection circuit, a pressure sensor capable of measuring the intensity (pressure) of a touch, and/or a fingerprint sensor.

The audio holes 205 and 208 may include a microphone hole 205 and a speaker hole 208.

A microphone is disposed inside of the housing 210 to acquire external sound, and, according to an embodiment, a plurality of microphones may be disposed to detect directions of the sound.

The speaker hole 208 may be disposed inside of the housing 210 and used as an external speaker and a receiver for calls.

According to an embodiment, a speaker may be included without a speaker hole (e.g., a piezo speaker).

The sensor module 211 may generate an electrical signal or data value corresponding to the internal operational state or the external environmental state of the wearable electronic device 100.

In an embodiment, the sensor module 211 may include a biometric sensor (e.g., an HRM sensor) disposed on the second surface 210B of the housing 210.

The wearable electronic device 100 may further include at least one of a sensor module (not shown)—for example, a gesture sensor, a gyro sensor, a pressure sensor, a magnetic sensor, an acceleration sensor, a grip sensor, a color sensor, an infrared (IR) sensor, a biometric sensor, a temperature sensor, a humidity sensor, or an illuminance sensor.

The key input devices 202, 204a, and 204b may include a wheel key 202 disposed on the first surface 210A of the housing 210 and rotatable in at least one direction, and/or the side key buttons 204a and 204b disposed on the side surface 210C of the housing 210.

The wheel key 202 may be in a shape corresponding to the shape of the first plate 201.

In another embodiment, the wearable electronic device 100 may not include some or all of the above-mentioned key input devices 202, 204a, and 204b, and the key input devices 202, 204a, and 204b that are not included may be implemented in the form of soft keys on the display (220 of FIG. 3).

The connector hole 209 may accommodate a connector (e.g., a USB connector) for transmitting and receiving power and/or data with an external electronic device, and may include another connector hole (not shown) for receiving a connector for transmitting and receiving audio signals with an external electronic device.

The wearable electronic device 100 may further include, for example, a connector cover (not shown) that covers at least a portion of the connector hole 209 and blocks the inflow of external foreign substances into the connector hole.

The wearing members 215 and 216 may be removably fastened to at least a portion of the housing 210 using locking members 216a and 215b.

The locking members 216a and 215b may include a fastening element, such as a pogo pin, and may be replaced by a protrusion(s) or recess(es) formed in the wearing members 215 and 216 according to an embodiment.

For example, the wearing members 215 and 216 may be coupled in a manner that engages a groove or protrusion formed in the housing 210.

The wearing members 215 and 216 may include one or more of a fixing member 217, a fixing member fastening hole 215a, a band guide member 218, and a band fixing ring 219.

The fixing member 217 may be configured to fix the housing 210 and the wearing members 215 and 216 to a part of the user's body (e.g., wrist, ankle).

The fixing member 217 may be introduced into the fixing member fastening hole 215a to secure the housing 210 and the wearing members 215 and 216 to a part of the user's body.

The band guide member 218 is configured to limit the range of movement of the fixing member 217 when the fixing member 217 is fastened to the fixing member fastening hole 215a, thereby allowing the wearing members 215 and 216 to be fastened in close contact with a part of the user's body.

The band fixing ring 219 may limit the range of movement of the wearing members 215 and 216 when the fixing member 217 and the fixing member fastening hole 215a are fastened.

Referring to FIG. 3 below, the wearable electronic device 100 may include the housing 210 (or a side bezel structure), the wheel key 202, the first plate 201, the display 220, a first antenna 250, a supporting member 260 (e.g., a bracket), a battery 245, a printed circuit board 240, an auxiliary circuit board 255, a coil assembly 280, a sealing member 290, the second plate 292, and the wearing members 215 and 216.

At least one of the components of the wearable electronic device 100 may be identical to or similar to at least one of the components of the wearable electronic device 100 of FIG. 1 or FIG. 2, and any duplicate description will be omitted below.

The first antenna 250 may include, for example, a near field communication (NFC) antenna, a wireless charging antenna, and/or a magnetic secure transmission (MST) antenna.

The first antenna 250 may, for example, perform a short-range communication with an external device, wirelessly transmit and receive power required for charging, and transmit a magnetic-based signal including a short-range communication signal or payment data.

In other embodiments, the antenna structure may be formed by a portion or combination of the housing 210 and/or the supporting member 260.

In an embodiment, the supporting member 260 may be disposed within the wearable electronic device 100 and connected to the housing 210, or may be formed integrally with the housing 210.

The supporting member 260 may be formed of, for example, a metallic material and/or a non-metallic (e.g., polymer) material.

The supporting member 260 may have one surface coupled the display 220 and the other surface coupled to the printed circuit board 240.

The battery 245 is a device for supplying power to at least one component of the wearable electronic device 100, and may include, for example, a non-rechargeable primary battery, a rechargeable battery, or a fuel cell.

At least a portion of the battery 245 may be disposed substantially coplanar with, for example, the printed circuit board 240.

The battery 245 may be integrally placed inside the wearable electronic device 100, or may be detachably disposed with the wearable electronic device 100.

A processor, memory, and/or interface may be disposed on the printed circuit board 240. The processor may include one or more of, for example, a central processing unit, an application processor, a graphic processing unit (GPU), a sensor processor, or a communication processor. The memory may include, for example, volatile memory or non-volatile memory. The interface may include, for example, a high-definition multimedia interface (HDMI), a universal serial bus (USB) interface, a secure digital (SD) card interface, and/or an audio interface. The interface may electrically or physically connect, for example, the wearable electronic device 100 with an external electronic device and may include a USB connector, an SD card/multimedia care (MMC) connector, or an audio connector.

The auxiliary circuit board 255 may be disposed between the printed circuit board 240 and the second plate 292. The auxiliary circuit board 255 may include an antenna, for example, the near field communication (NFC) antenna, the wireless charging antenna, and/or the magnetic secure transmission (MST) antenna. The auxiliary circuit board 255 may, for example, perform short-range communication with an external device, wirelessly transmit and receive power required for charging, or transmit a magnetic-based signal including a short-range communication signal or payment data. In an embodiment, the antenna structure may be formed by a portion or combination of the housing 210 and/or the second plate 292.

In an embodiment, when the wearable electronic device 100 includes a sensor module (e.g., the first sensor module 211 of FIG. 2), a separate sensor circuit or sensor element may be disposed on the sensor circuit disposed on the auxiliary circuit board 255. The sensor circuit or sensor element may include, for example, a light emitting element, a photoelectric conversion element or an electrode pad.

In an embodiment, the coil assembly 280 (e.g., a wireless charging coil) may be disposed between the printed circuit board 240 and the second plate 292. The coil assembly 280 may be electrically connected to the printed circuit board 240 and/or the auxiliary circuit board 255. For example, the coil assembly 280 may be disposed around the auxiliary circuit board 255. The coil assembly 280 may be a charging coil in which a current is induced in response to a magnetic field of an externally disposed wireless charging device. In an embodiment, the auxiliary circuit board 255 and the coil assembly 280 may together form a wireless charging assembly. For example, the auxiliary circuit board 255 and the coil assembly 280 may be formed integrally.

The sealing member 290 may be positioned between the housing 210 and the second plate 292. The sealing member 290 may be configured to block moisture and foreign substances from flowing from the outside into the space surrounded by the housing 210 and the second plate 292.

The wearing members 215 and 216 may be connected to different regions of the housing 210 and may be disposed in a symmetrical shape.

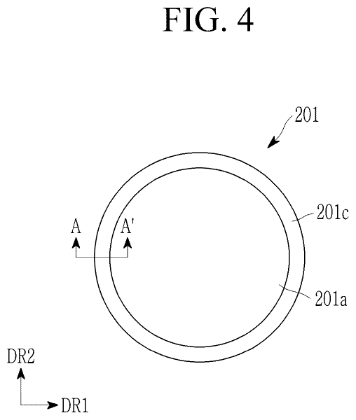

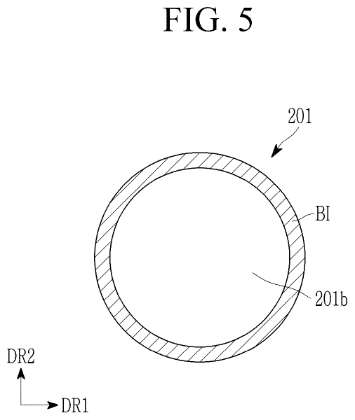

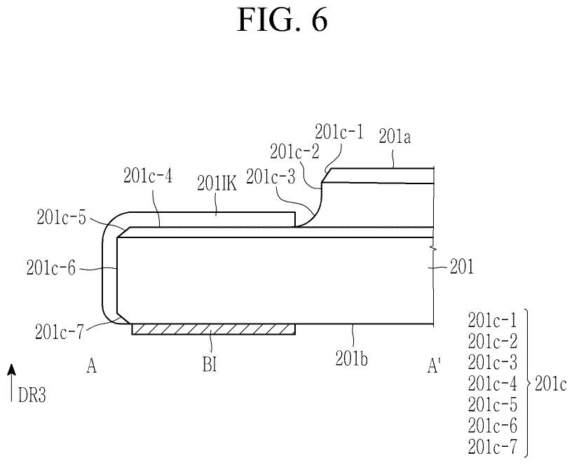

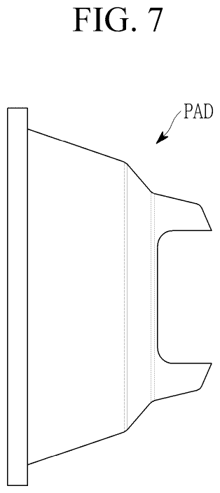

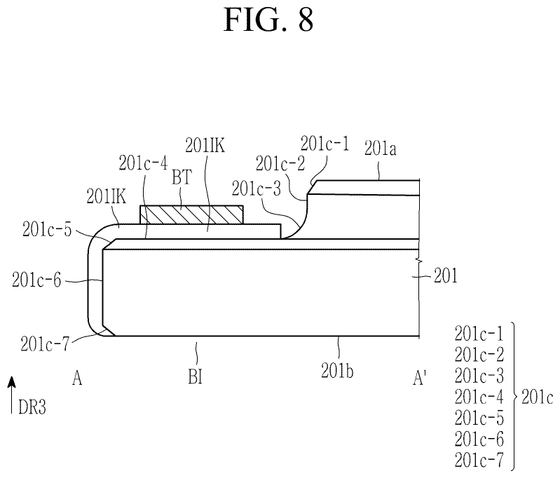

Hereinafter, a first plate according to an embodiment will be described with reference to FIGS. 4 to 8. FIG. 4 is a top plan view of the front surface of a first plate according to an embodiment, FIG. 5 is a top plan view of the rear surface of the first plate according to an embodiment, FIG. 6 is a side view of the first plate according to an embodiment, FIG. 7 is a cross-sectional view showing a pad according to an embodiment, and FIG. 8 is a side view of the embodiment of FIG. 6 with a light shielding adhesive layer added.

Referring to FIGS. 4 to 6, the first plate 201 according to an embodiment may have a circular shape in a plan view. However, it is not limited thereto, and the shape of the first plate 201 may be changed according to the shape of the display of the wearable electronic device.

The first plate 201 may define or form at least a portion of the front surface (e.g., the third direction) of the wearable electronic device. As described above, a sensor module, a display, etc. may be disposed on the back surface of the first plate 201.

The first plate 201 may include an insulating material. The insulating material may include coated or colored glass, ceramic, synthetic resin, sapphire, or a combination of two or more of the above materials.

In an embodiment, the first plate 201 may include a first surface 201a facing the exterior of the wearable electronic device 100 (see FIG. 1), a second surface 201b facing the first surface 201a, and a first side surface 201c connecting the first surface 201a and the second surface 201b.

Meanwhile, as shown in FIG. 5, a light shielding printed layer BI may be disposed on the second surface 201b. The light shielding printed layer BI may include a light shielding material. The light shielding printed layer BI may overlap a portion of the second surface 201b. The light shielding printed layer BI may be disposed along an edge of the second surface 201b. The light shielding printed layer BI may not overlap the first surface 201a. The light shielding printed layer BI may include an opening that is disposed in an area corresponding to the center of the second surface 201b.

FIG. 6 is a cross-sectional view taken along line A-A′ of FIG. 4. Referring to FIG. 6, the first side surface 201c according to an embodiment may have a stepped shape. The first side surface 201c may have a stair shape. Specifically, the first side surface 201c may include a 1-1 side surface 201c-1, a 1-2 side surface 201c-2, a 1-3 side surface 201c-3, a 1-4 side surface 201c-4, a 1-5 side surface 201c-5, a 1-6 side surface 201c-6, and a 1-7 side surface 201c-7.

The 1-1 side surface 201c-1 may be directly connected to the first surface 201a. The 1-1 side surface 201c-1 may have a shape inclined with respect to the first surface 201a. The 1-1 side surface 201c-1 may be inclined with respect to a first direction DR1 or a second direction DR2 and may have a tapered shape in a cross-section.

The 1-2 side surface 201c-2 may be connected to the 1-1 side surface 201c-1. The 1-2 side surface 201c-2 may connect the 1-1 side surface 201c-1 and the 1-3 side surface 201c-3. The 1-2 side surface 201c-2 may be parallel to a third direction DR3. The 1-2 side surface 201c-2 may be perpendicular to the plane formed by the first direction DR1 and the second direction DR2, but it is not limited thereto.

The 1-3 side surface 201c-3 may connect the 1-2 side surface 201c-2 and the 1-4 side surface 201c-4. The 1-3 side surface 201c-3 may have a curved shape in a cross-section as shown in FIG. 6.

The 1-4 side surface 201c-4 may connect the 1-3 side surface 201c-3 and the 1-5 side surface 201c-5. Although the 1-4 side surface 201c-4 is named as a side surface, it may actually be parallel to the plane formed by the first direction DR1 and the second direction DR2. In other words, the 1-4 side surface 201c-4 may be parallel to the first surface 201a and the second surface 201b.

The 1-5 side surface 201c-5 may connect the 1-4 side surface 201c-4 and the 1-6 side surface 201c-6. The 1-5 side surface 201c-5 may have an inclined shape with respect to the 1-4 side surface 201c-4. The 1-5 side surface 201c-5 may be inclined with respect to the first direction DR1 or the second direction DR2 and may have a tapered shape in a cross-section.

The 1-6 side surface 201c-6 may be connected to the 1-5 side surface 201c-5. The 1-6 side surface 201c-6 may connect the 1-5 side surface 201c-5 and the 1-7 side surface 201c-7. The 1-6 side surface 201c-6 may be parallel to the third direction DR3. The 1-6 side surface 201c-6 may be perpendicular to the plane formed by the first direction DR1 and the second direction DR2, but it is not limited thereto.

The 1-7 side surface 201c-7 may connect the 1-6 side surface 201c-6 and the second surface 201b. The 1-7 side surface 201c-7 may have an inclined shape with respect to the 1-6 side surface 201c-6 and the second surface 201b. The 1-7 side surface 201c-7 may be inclined with respect to the first direction DR1 or the second direction DR2 and may have a tapered shape in a cross-section.

Although this specification has described the 1-1 side surface 201c-1 to the 1-7 side surface 201c-7, it is not limited thereto and the side surface of the first plate 201 may be modified in various ways. In this case, the first side surface 201c may include a first sub-side surface connected to the first surface 201a, a second sub-side surface connected to the first sub-side surface, and a third sub-side surface positioned between the second sub-side surface and the second surface 201b. In this specification, the first sub-side surface may include the 1-1 side surface 201c-1, the 1-2 side surface 201c-2, and the 1-3 side surface 201c-3. The second sub-side surface may include the 1-4 side surface 201c-4. The third sub-side surface may include the 1-5 side surface 201c-5, the 1-6 side surface 201c-6, and the 1-7 side surface 201c-7. However, it is not limited to the above shapes.

According to an embodiment, a portion of the first plate 201 may be covered with a protective ink layer 201IK. The protective ink layer 201IK may cover a portion of the side surface of the first plate 201. The protective ink layer 201IK may cover the 1-4 side surface 201c-4, the 1-5 side surface 201c-5, the 1-6 side surface 201c-6, and the 1-7 side surface 201c-7. However, it is not limited thereto, and the side surface of the first plate 201 may be freely covered to prevent the corner of the first plate 201 from being broken. The protective ink layer 201IK may cover at least a portion of the side surface of the first plate 201.

The protective ink layer 201IK may not overlap the first surface 201a and the second surface 201b. The protective ink layer 201IK may be spaced apart from the first surface 201a and the second surface 201b. When the protective ink layer 201IK is disposed on the first surface 201a and the second surface 201b, interference problems with other components may occur. The protective ink layer 201IK may cover at least a portion of the side surface connecting the first surface 201a and the second surface 201b.

The protective ink layer 201IK may be transparent. Additionally, the thickness of the protective ink layer 201IK may be about 10 micrometers or less, for example, about 5 micrometers or less. The protective ink layer 201IK may be provided in a relatively thin thickness.

The protective ink layer 201IK may include at least one of an acrylate-based resin, a methacrylate-based resin, a polyisoprene-based resin, a vinyl-based resin, an epoxy-based resin, a urethane-based resin, a cellulose-based resin, a siloxane-based resin, a polyamide-based resin, and a perylene-based resin.

In this specification, the “˜˜-based” resin means a resin that contains a functional group of “˜˜”.

The material of the protective ink layer 201IK is not limited thereto, and the protective ink layer 201IK may include any material for protecting the first plate 201.

On the other hand, the protective ink layer 201IK may be manufactured through an inkjet process, a spin coating process, a photolithography process, a silk screen process, or a pad printing process.

The pad printing process may use a pad as shown in FIG. 7.

The pad printing process is a method of printing ink in which ink is transferred to the target object by contact between the target object to be printed (e.g., the first plate) and the pad.

In the region where the pad and the target object make contact, the ink transferred to the pad may be printed on the target object depending on the surface energy between the pad ink and the target object ink.

When using a pad printing process, ink may be printed stably even on a shape with steps, such as the side surface of the first plate 201.

That is, the protective ink layer may be formed stably.

Referring to FIG. 8, a wearable electronic device according to an embodiment may include a light shielding adhesive layer BT.

The light shielding adhesive layer BT may overlap at least a portion of the protective ink layer 201IK.

For example, the protective ink layer 201IK and the light shielding adhesive layer BT may be positioned on the 1-4 side surface 201c-4.

The protective ink layer 201IK may be coupled with the housing 210 by a light shielding adhesive layer BT.

The light shielding adhesive layer BT may contain black ink.

The light shielding adhesive layer BT may be black tape.

A wearable electronic device according to an embodiment may include a protective ink layer covering a portion of the side surface of the first plate.

The protective ink layer may prevent the side surface of the first plate, which is formed in a stepped shape, from being broken.

Additionally, the adhesive force may be improved through a protective ink layer when coupling the housing and the first plate.

While this disclosure has been described in connection with what is presently considered to be practical embodiments, it should be understood that the disclosure is not limited to the disclosed embodiments, but, on the contrary, is intended to cover various modifications and equivalent arrangements included within the spirit and scope of the appended claims.

What is claimed is:

1. A wearable electronic device, comprising:
a display;
a first plate positioned on the display;
a protective ink layer covering a portion of the first plate; and
a housing positioned on the first plate,
wherein the first plate comprises
a first surface;
a first side surface connected to the first surface; and
a second surface connected to the first side surface and overlapping the first surface, and
wherein the first side surface has a stepped shape and the protective ink layer covers a portion of the first side surface.

2. The wearable electronic device of claim 1, wherein the protective ink layer does not overlap the first surface or the second surface.

3. The wearable electronic device of claim 1, wherein the protective ink layer exposes a remaining portion of the first side surface.

4. The wearable electronic device of claim 1, wherein the first side surface comprises:
a first sub-side surface connected to the first surface;
a second sub-side surface connected to the first sub-side surface; and
a third sub-side surface connected to the second surface and a second sub-side surface.

5. The wearable electronic device of claim 4, wherein the second sub-side surface is parallel to the first surface and the second surface.

6. The wearable electronic device of claim 5, wherein the protective ink layer covers at least a portion of the second sub-side surface.

7. The wearable electronic device of claim 5, wherein the protective ink layer covers at least a portion of the third sub-side surface.

8. The wearable electronic device of claim 4, further comprising a light shielding adhesive layer positioned on the second sub-side surface.

9. The wearable electronic device of claim 9, wherein the light shielding adhesive layer is in contact with the protective ink layer.

10. The wearable electronic device of claim 9, wherein the light shielding adhesive layer is positioned between the protective ink layer and the housing.

11. The wearable electronic device of claim 1, further comprising a light shielding printed layer positioned on a rear surface of the first plate.

12. A wearable electronic device, comprising:
a display;
a first plate positioned on the display;
a protective ink layer covering a portion of the first plate; and
a housing positioned on the first plate,
wherein the first plate comprises:
a first surface;
a first side surface connected to the first surface; and
a second surface connected to the first side surface and overlapping the first surface, and
wherein the protective ink layer covers a portion of the first side surface and exposes a remaining portion of the first side surface, and the housing encloses at least a portion of the first side surface.

13. The wearable electronic device of claim 12, wherein the protective ink layer does not overlap the first surface or the second surface.

14. The wearable electronic device of claim 12, wherein the first side surface comprises:
a first sub-side surface connected to the first surface;
a second sub-side surface connected to the first sub-side surface; and
a third sub-side surface connected to the second surface and a second sub-side surface.

15. The wearable electronic device of claim 14, wherein the second sub-side surface is parallel to the first surface and the second surface.

16. The wearable electronic device of claim 15, wherein the protective ink layer covers at least a portion of the second sub-side surface.

17. The wearable electronic device of claim 15, wherein the protective ink layer covers at least a portion of the third sub-side surface.

18. The wearable electronic device of claim 14, further comprising a light shielding adhesive layer positioned on the second sub-side surface.

19. The wearable electronic device of claim 19, wherein the light shielding adhesive layer is positioned between the protective ink layer and the housing.

20. The wearable electronic device of claim 12, further comprising a light shielding printed layer positioned on a rear surface of the first plate.
